(19) United States
(12) Patent Application Publication
(10) Pub. No.: US 2005/0092780 A1
(43) Pub. Date: May 5, 2005

(54) Container with air intake mechanism

(76) Inventor: Shigeru Yamana, Toyama (JP)

Correspondence Address: PARKHURST & WENDEL, L.L.P., 1421 PRINCE STREET, SUITE 210, ALEXANDRIA, VA, 22314-2805, US

(21) Appl. No.: 10/506,068

(22) PCT Filed: Feb. 28, 2003
(86) PCT No.: PCT/JP03/02386

(30) Foreign Application Priority Data
Mar. 5, 2002 (JP) 200258129
Jul. 15, 2002 (JP) 2002205866

(51) Int. Cl. B67D 1/00

(52) U.S. Cl. 222/478; 222/468

(57) ABSTRACT

An one-mouth container for storing liquid capable of preventing pulsating flow and controlling a discharging speed approximately at a constant independently of the amount of an internal liquid in the container when the internal liquid is discharged, in which a blow-molded portion (23) is formed on the container body side portion of a container mouth portion; a narrowed portion (24), a discharge port (31) and an air channel (11) extending from a side wall of the blow-molded portion (23) to a space at an upper part of the container body are formed by narrowing down the narrowed portion; the air channel has such a length that air supplied through the air channel (11) is released directly in the internal liquid; and both a discharge port (31) and an air port (25) are formed at the narrowed portion (24).

### TECHNICAL FIELD

The present invention relates to a container for storing liquid, and more particularly to a container for storing liquid having a function, when an internal liquid remained in the container is discharged, capable of keeping liquid discharging speed approximately constant independently of the amount of the internal liquid and preventing pulsating flow from occurring.

### BACKGROUND ART

As a conventional container of this kind, for example, there have been a two-mouth container as illustrated in FIG. 22 or a container having an air intake mechanism as illustrated in FIG. 23 (U.S. Pat. No. 5,340,000).

### DISCLOSURE OF THE INVENTION

The two-mouth container illustrated in FIG. 22 has such a drawback that both the two mouths have to be opened to make an internal liquid discharge smooth without pulsation when the liquid in the container is discharged. Another drawback is that the two-mouth type container has itself a problem involving rise in production cost because of its shape and a need to provide two caps for each container. On the contrary, the container as illustrated in FIG. 23 has one mouth and is easy to handle. But such one-mouth container has a large air-supplying tube which is also used as a handgrip, so that degree of freedom of design is somewhat limited.

Further, these conventional containers have common characteristics that air to be supplied into the container is introduced directly into an internal space of the container without passing through the internal liquid. This type of air intake mechanism can realize very smooth discharge of the liquid since there is no resistance caused by the internal liquid when the internal liquid is replaced by air. However, the discharging speed varies with the height of the surface of the internal liquid. That is, the liquid is discharged at a higher speed at an initial stage of the discharge, when the large amount of the internal liquid is remained in the container. The discharging speed gradually decreases with decrease of the amount of the internal liquid.

Accordingly, there has been a need to control the discharging speed at a constant by adjusting an angle of inclination of the container in concert with the decrease of the internal liquid.

These above mentioned problems can be solved by a first aspect of the present invention in which a blow-molded portion 23, whose opening is larger than that of a container mouth portion 21, is formed by using pressure of a blow molding at a position under the container mouth portion; a narrowed portion 24 and a discharge port 31 in the narrowed portion 24 are formed by narrowing down on a container body side portion of the blow-molded portion 23. And an air channel 11 extending from and connecting a side-wall of the blow-molded portion 23 positioned over the narrowed portion 24 to an inner upper space of the body. The air channel 11 has such a short length that air supplied through the air channel 11 is released directly in the internal liquid in the container when the internal liquid is discharged.

A second aspect of the present invention is characterized by that the blow-molded portion 23, whose opening is larger than that of the container mouth portion 21, is formed by using pressure of a blow molding at the position under the container mouth portion, and the narrowed portion 24, the discharge port 31 and an air port 25 are formed simultaneously by narrowing down on a container body side portion of the blow-molded portion 23.

Furthermore in order to improve its usability, the discharge port 31 has an approximately the same axis along it of the mouth portion 21 and has approximately the same size and shape as those of the container mouth portion 21.

Experiments were carried out using various containers as shown in FIG. 1 to determine a relation between the amount of an internal liquid remained in a container and a discharging speed in relation to the length of the air channel 11.

The length of the air channel 11 in case A is set at 20˜30 mm which is the minimum length of necessity for ensuring pulsation-free flow when the internal liquid is discharged; whereas in case B, the length of the air channel is about a half of the height of the container; and in case C, the length of the air channel is approximately equal to the height of the container. All containers were nearly fully filled up with water and then containers were placed upside down to start discharging water. The surface of water was lowering with progress of discharge of the internal liquid. A discharging speed was measured at each height of the liquid surface indicated by 1 to 6. Discharging speed was measured in terms of time period during which about 200 ml of water was discharged. The test results are shown in the next Table.

[image]

From these results, it is recognized that when the front edge of the air channel 11 is under the surface of the liquid, a specific discharging speed can be maintained that is specifically determined by the length of the air channel 11. Whereas when the front edge of the air channel 11 emerges from under the surface of the liquid, the discharging speed changes in proportion to the height of the surface of the liquid. In case of A where the length of the air channel 11 is the shortest, the front edge of the air channel is always under the surface of the liquid, discharging speed is saved and controlled, showing an approximately constant discharging speed independently of the height of the liquid surface. The liquid was discharged extremely smooth as long as the front edge of the air channel was placed above the liquid surface. Although slight pulsation was observed when the front edge of the air channel was under the surface of the liquid, such slight pulsation causes no problem in practical use.

### EFFECTS OF THE INVENTION

1. The pulsation-free flow, when the internal liquid is discharged, can be realized with the one-mouth container.

2. Discharging speed is kept approximately constant independently of the amount of the internal liquid remained in the container, so that there is no need to control the discharging speed by changing the angle of inclination of the container.

3. The air intake mechanism is compact in size, so that the container can be designed more freely.

4. When molding, conventional molding processes can be used, so that there is no need to use a special molding machine or die.

5. No sizable projection exists at the inner portion of the mouth, so that no difficulty arises in filling liquid or inserting a liquid-filling pump etc. into the container.

### BRIEF DESCRIPTION OF THE DRAWINGS

FIG. 1 is a view illustrating a state of a discharging test.

FIG. 2 includes a front view, a plane view and a sectional view taken along a line A-A, of a container according to a first embodiment.

FIG. 3 is an enlarged sectional view of a mouth portion according to the first embodiment.

FIG. 4 is a sectional view taken along a line B-B in FIG. 3.

FIG. 5 is a sectional view taken along a line C-C in FIG. 3.

FIG. 6 is an enlarged sectional view of the mouth portion at a time of discharging an internal liquid according to the first embodiment.

FIG. 7 includes a front view, a side view and a plane view of another container according to a second embodiment.

FIG. 8 is an enlarged sectional view of a mouth portion according to the second embodiment.

FIG. 9 is a sectional view taken along a line D-D in FIG. 8.

FIG. 10 is a sectional view taken along a line E-E in FIG. 8.

FIG. 11 includes a front view, a side view and a plane view of a still another container according to a third embodiment.

FIG. 12 includes a front view, a side view and a plane view of another container according to a fourth embodiment.

FIG. 13 is an enlarged sectional view of a mouth portion according to the fourth embodiment.

FIG. 14 is a sectional view taken along a line F-F in FIG. 13.

FIG. 15 is a sectional view taken along a line G-G in FIG. 13.

FIG. 16 is a sectional view taken along a line H-H in FIG. 13.

FIG. 17 is an enlarged sectional view of the mouth portion illustrating a state of discharging according to the fourth embodiment.

FIG. 18 includes a front view, a side view and a plane view of another container according to a fifth embodiment.

FIG. 19 is an enlarged sectional view of a mouth portion according to the fifth embodiment.

FIG. 20 is a sectional view taken along a line I-I in FIG. 19.

FIG. 21 is a sectional view taken along a line J-J in FIG. 19.

FIG. 22 is a view illustrating a conventional two-mouth container.

FIG. 23 is a view illustrating a conventional container with an air intake mechanism.

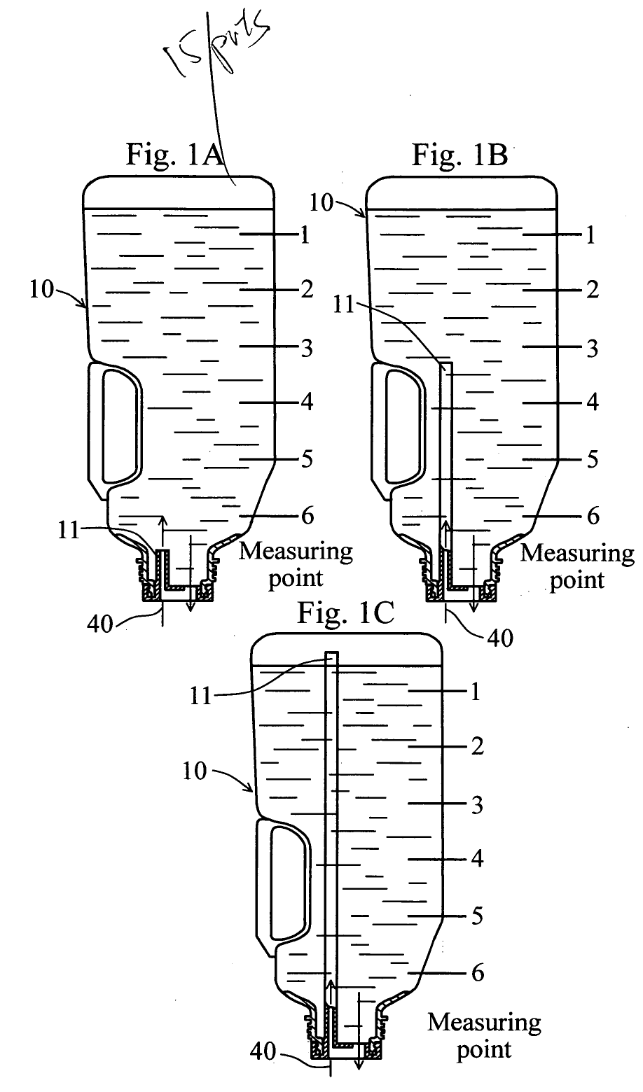

### REFERENCE NUMERALS

11: air channel,

21: container mouth portion

22: body of the container

23: blow-molded portion

24: narrowed portion

25: air port

31: discharge port

### EMBODIMENTS OF THE INVENTION

First Embodiment

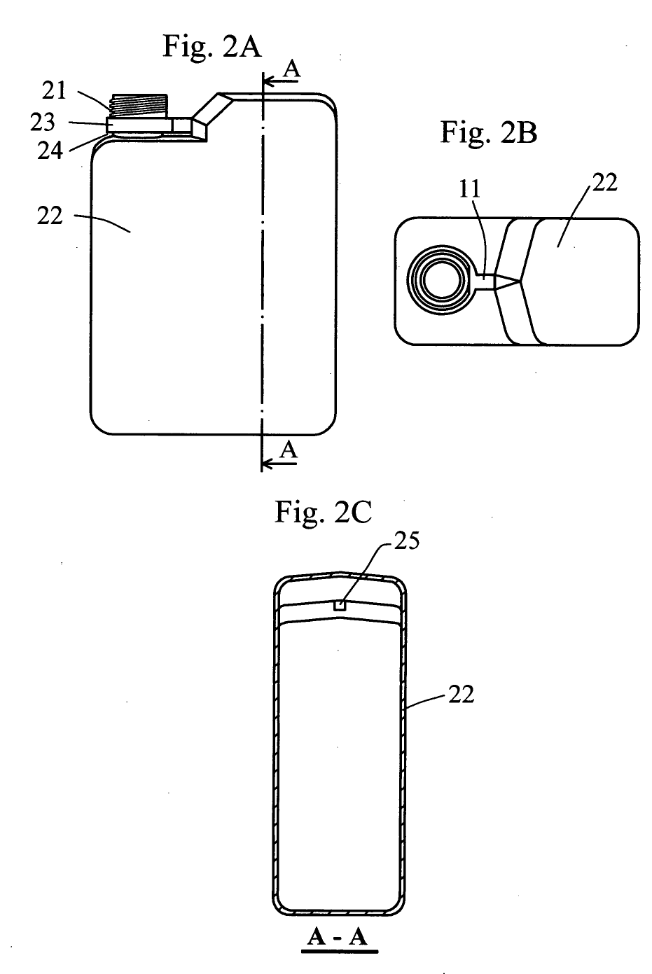

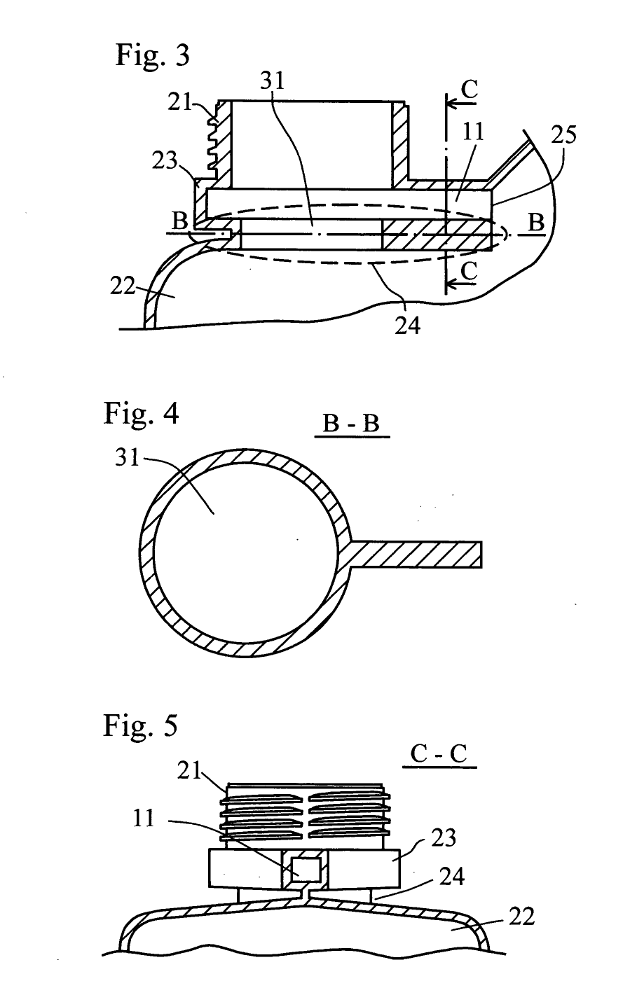

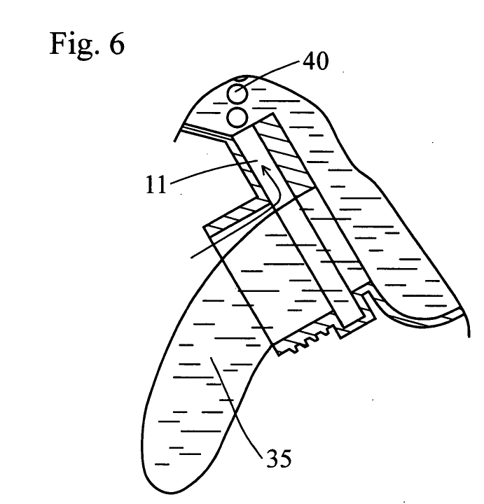

FIG. 2 includes a front view, a plane view and a sectional view taken along a line A-A, of a container according to a first embodiment, and FIG. 3 is an enlarged sectional view of a mouth portion. FIG. 4 is a sectional view taken along a line B-B in FIG. 3, and FIG. 5 is a sectional view taken along a line C-C in FIG. 3, as well. FIG. 6 is an enlarged sectional view of the mouth portion at a time of discharging an internal liquid according to the first embodiment.

Air, that is supplied into a container through an air channel 11, is released in the internal liquid remained in the container. According to this mechanism, a discharging speed of the liquid can be kept approximately constant independently of the amount of the internal liquid.

Second Embodiment

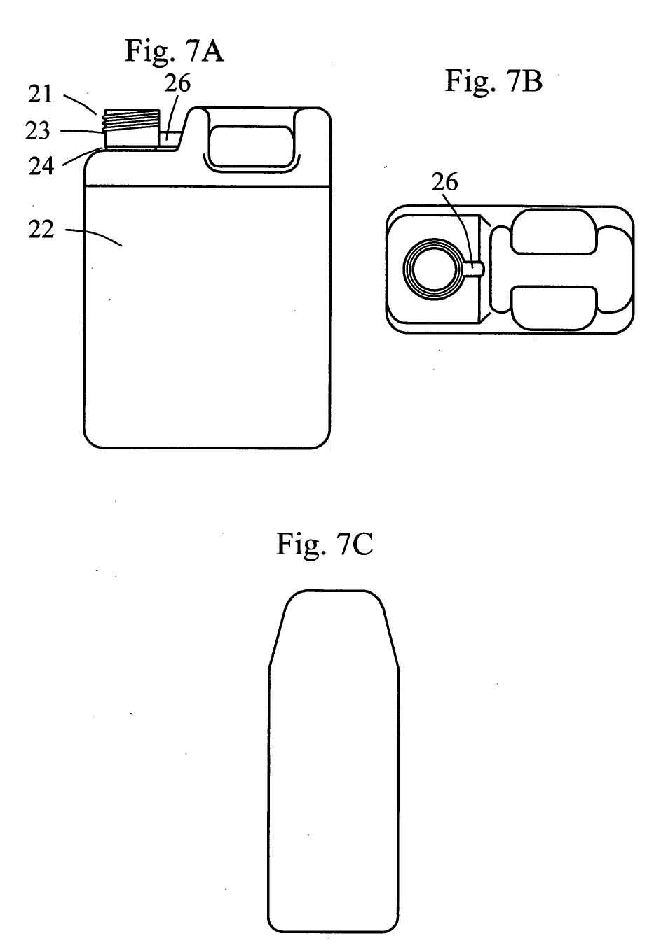

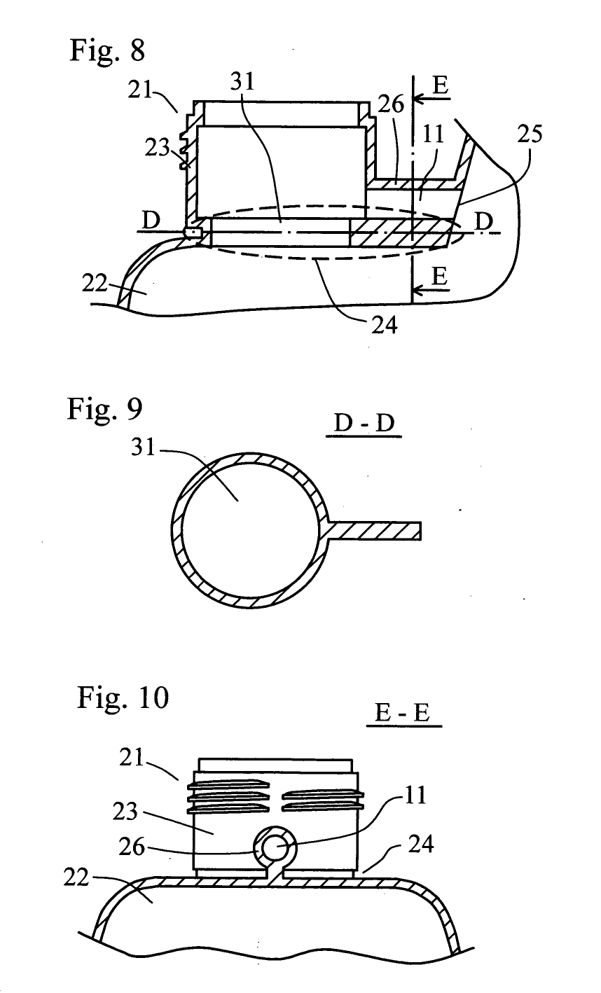

FIG. 7 includes a front view, a side view and a plane view of another container according to a second embodiment, and FIG. 8 is an enlarged sectional view of a mouth portion. FIG. 9 is a sectional view taken along a line D-D in FIG. 8, and FIG. 10 is a sectional view taken along a line E-E in FIG. 8, as well.

In the first embodiment, a blow-molded portion 23 is formed under a screw portion, but in the second embodiment, the blow-molded portion 23 includes the screw portion which is formed by a blow-molding process. In addition, the air channel 11 communicates with both the blow-molded portion 23 and an internal space of a base portion of a handle that is provided at an upper portion of a body of the container.

Third Embodiment

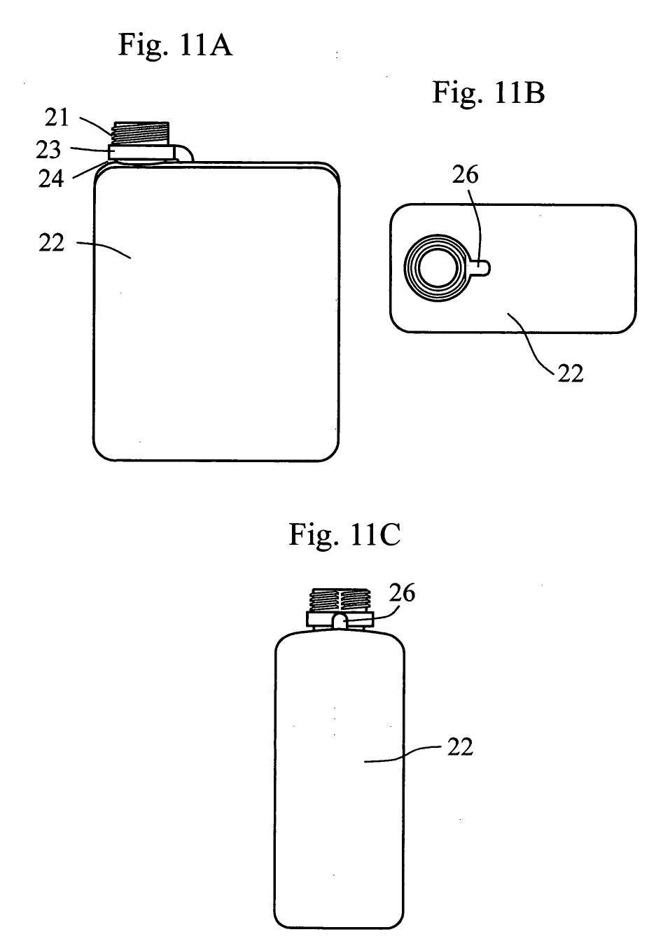

FIG. 11 includes a front view, a side view and a plane view of still another container according to a third embodiment. The air channel 11 is short in length and compact in size, so that the air channel 11 can be applied not only to a flat square type container but also to a round bilge type container.

Fourth Embodiment

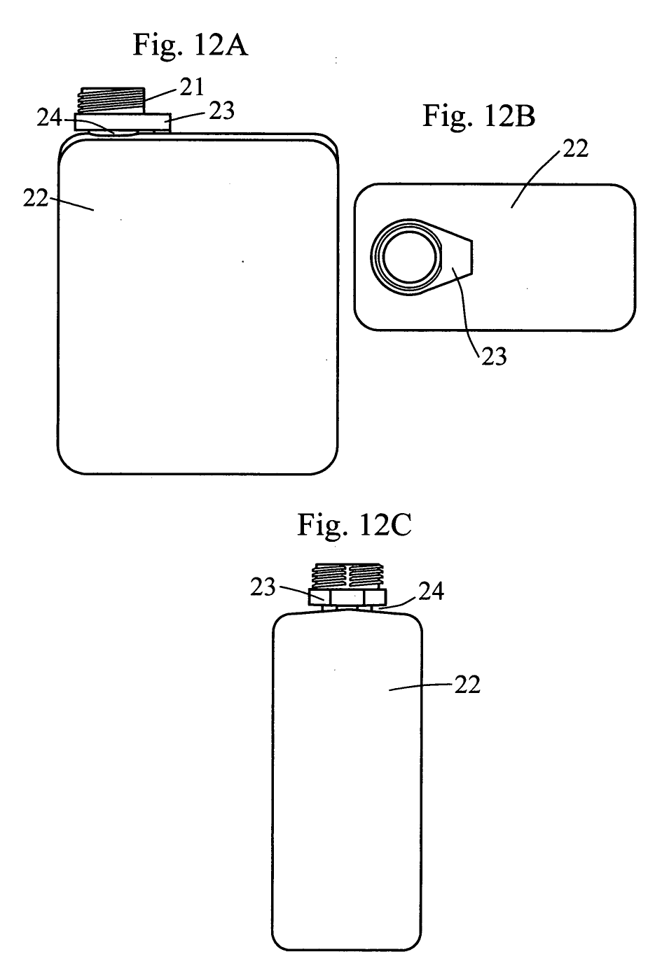

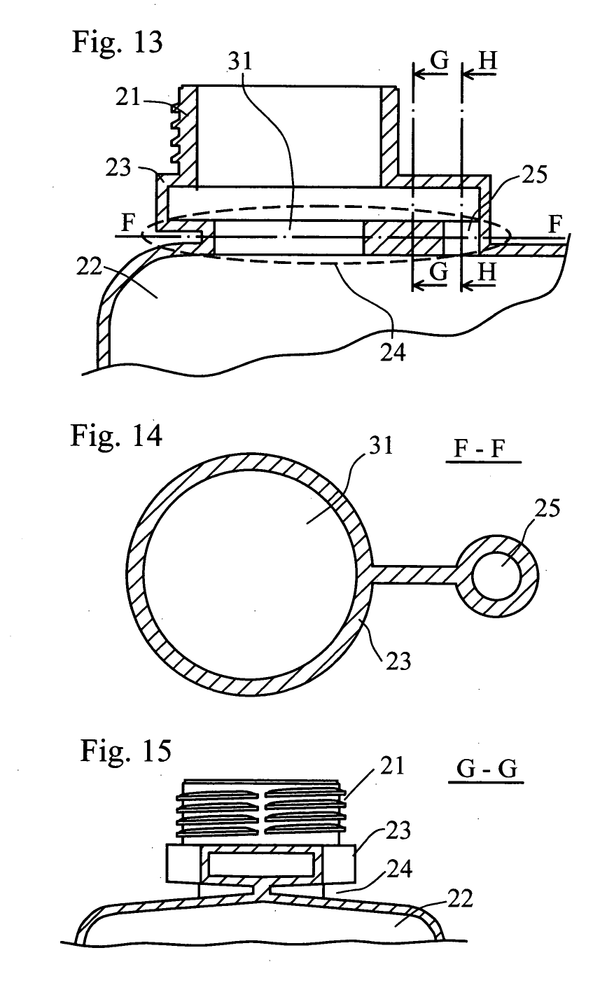

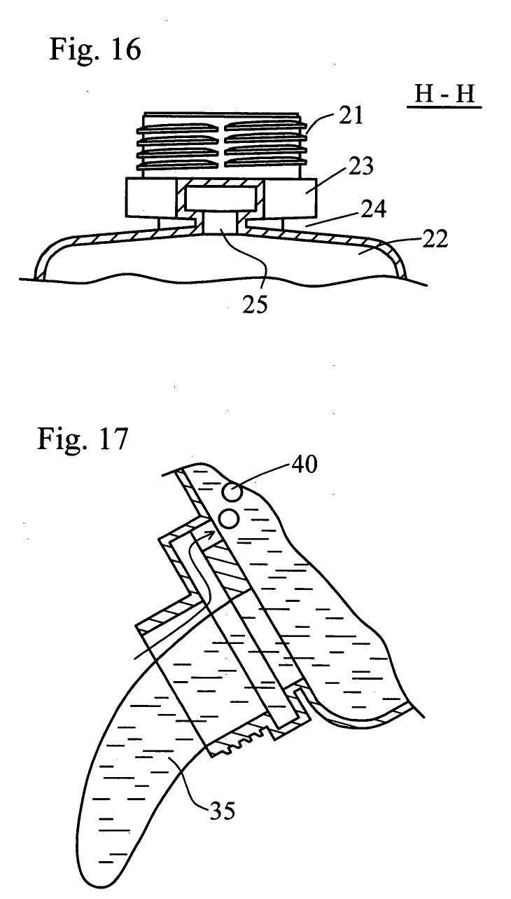

FIG. 12 includes a front view, a side view and a plane view of another container according to a fourth embodiment. FIG. 13 is an enlarged sectional view of its mouth portion and FIG. 14 is a sectional view taken along a line F-F in FIG. 13. FIG. 15 is a sectional view taken along a line G-G in FIG. 13, and FIG. 16 is a sectional view taken along a line H-H, as well. FIG. 17 is an enlarged sectional view of the mouth portion illustrating a state of discharge, according to the fourth embodiment.

Fifth Embodiment

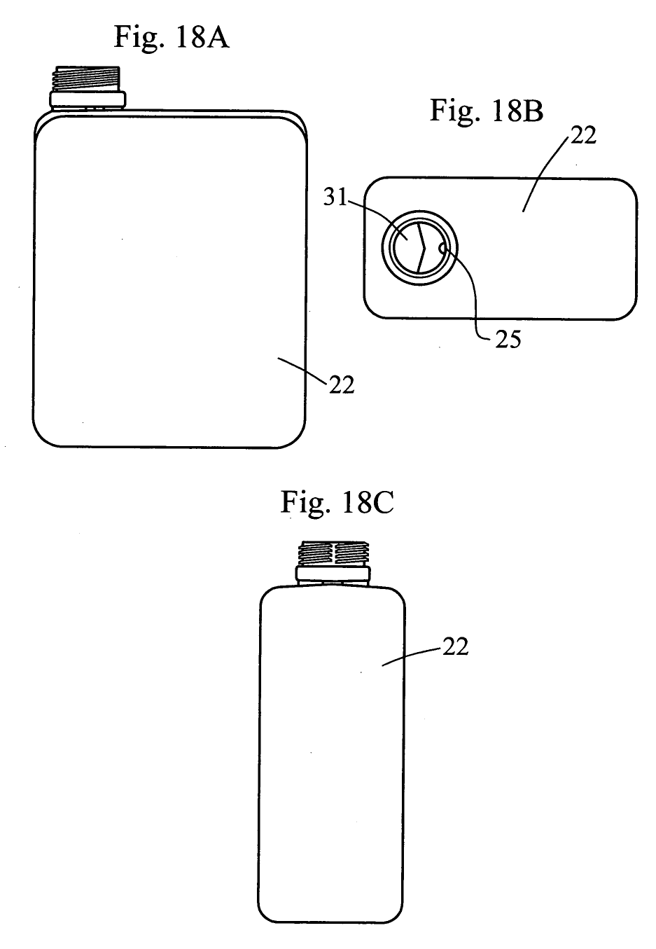

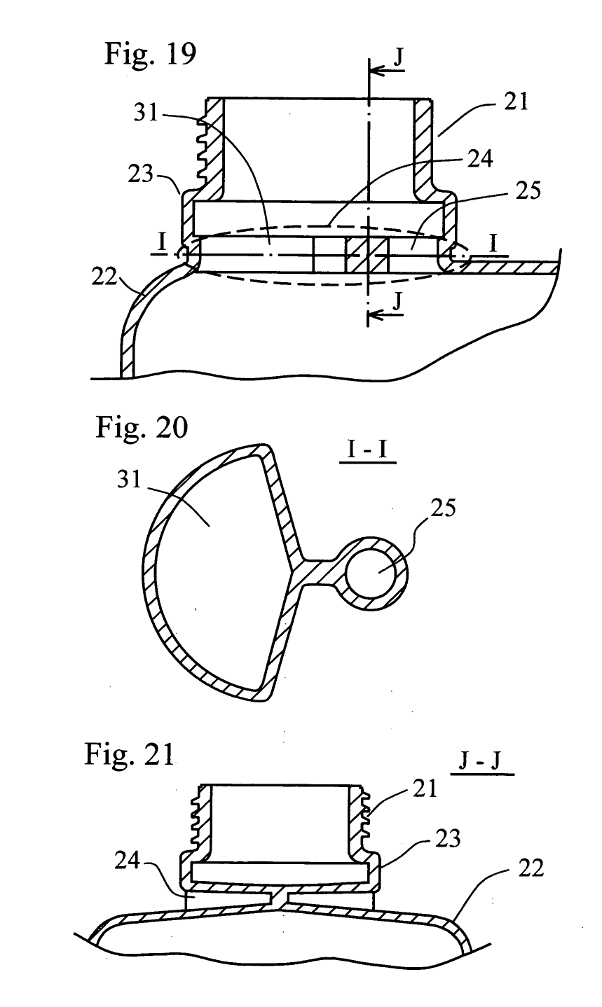

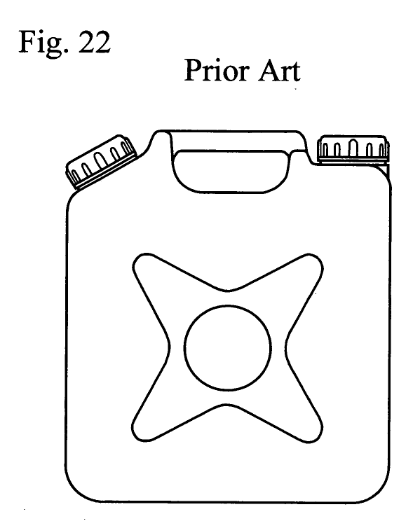

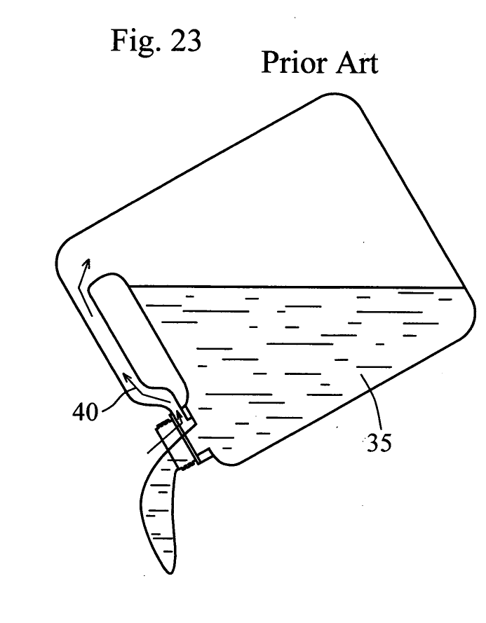

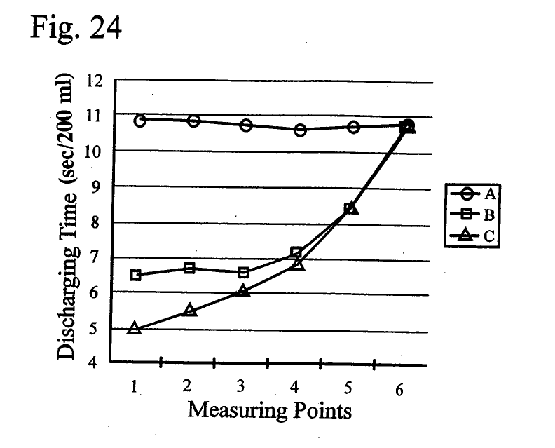

FIG. 18 includes a front view, a side view and a plane view of another container according to a fifth embodiment, and FIG. 19 is an enlarged sectional view of a mouth portion. FIG. 20 is a sectional view taken along a line I-I in FIG. 19, and FIG. 21 is a sectional view taken along a line J-J in FIG. 19, as well. In this embodiment, the air intake mechanism is much more compact in size, so that the air intake mechanism can be much easily applied not only to a square type container but also to a round bilge type container. However, a projection, which is peculiar to this type of air intake mechanism, is provided at an inner portion of the mouth, so that it is feared that there may cause a difficulty in inserting a liquid-filling nozzle etc. into the container.

1. A container with an air intake mechanism comprising:
a container mouth portion;
a blow-molded portion having an opening larger than an opening of the container mouth portion and formed by using a blow molding at a position under the container mouth portion;
a narrowed portion and a discharge port in the narrowed portion formed by narrowing down on a container body side portion of the blow-molded portion; and
an air channel extending from and connecting a side wall of the blow-molded portion positioned over the narrowed portion to an inner upper space of the container body, the air channel having such a length that air supplied through the air channel is released directly in an internal liquid in the container when the internal liquid is discharged.

2. The container with the air intake mechanism according to claim 1, wherein the narrowed portion, the discharge port and an air port are simultaneously formed by narrowing down a side portion of the container body side at the blow-molded portion.

3. The container with the air intake mechanism according to claim 1, wherein the discharge port has approximately a same axis as an axis of the container mouth portion and with approximately a same size and shape as a size and shape of the container mouth portion.

4. The container with the air intake mechanism according to claim 2, wherein the discharge port has approximately a same axis as an axis of the container mouth portion and with approximately a same size and shape as a size and shape of the container mouth portion.
